(19) United States
(12) Patent Application Publication
(10) Pub. No.: US 2009/0009432 A1
(43) Pub. Date: Jan. 8, 2009

(54) PLASMA DISPLAY PANEL

(75) Inventors: Changhyun KIM, Gyoungsangbuk-do (KR); Yoonlae CHO, Gyoungsangbuk-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/931,589

(22) Filed: Oct. 31, 2007

(30) Foreign Application Priority Data
Jul. 3, 2007 (KR) 10-2007-0066543

(51) Int. Cl. G09G 3/28

(52) U.S. Cl. 345/60

(57) ABSTRACT

A plasma display panel is disclosed. The plasma display panel includes a front substrate, a scan electrode and a sustain electrode positioned parallel to each other on the front substrate, an upper dielectric layer positioned on the scan electrode and the sustain electrode, a rear substrate positioned to be opposite to the front substrate, and a barrier rib that is positioned between the front and rear substrates and partitions a discharge cell. The upper dielectric layer includes a glass-based material and a cobalt (Co)-based material as a pigment. The barrier rib includes lead (Ph) equal to or less than 1,000 ppm (parts per million).

This application claims the benefit of Korean Patent Application No. 10-2007-0066543 filed on Jul. 3, 2007, which is hereby incorporated by reference.

### BACKGROUND OF THE DISCLOSURE

1. Field of the Disclosure

This document relates to a plasma display panel.

2. Description of the Related Art

The plasma display panel includes a phosphor layer inside discharge cells partitioned by barrier ribs and a plurality of electrodes.

A driving signal is supplied to the electrodes, thereby generating a discharge inside the discharge cells. When the driving signal generates a discharge inside the discharge cells, a discharge gas filled inside the discharge cells generates vacuum ultraviolet rays, which thereby cause phosphors formed inside the discharge cells to emit light, thus displaying an image on the screen of the plasma display panel.

### SUMMARY OF THE DISCLOSURE

In one aspect, a plasma display panel comprises a front substrate, a scan electrode and a sustain electrode positioned parallel to each other on the front substrate, an upper dielectric layer positioned on the scan electrode and the sustain electrode, the upper dielectric layer including a glass-based material and a cobalt (Co)-based material as a pigment, a rear substrate on which an address electrode is positioned to intersect the scan electrode and the sustain electrode, and a barrier rib that is positioned between the front substrate and the rear substrate and partitions a discharge cell, the barrier rib including lead (Pb) equal to or less than 1,000 ppm (parts per million).

In another aspect, a plasma display panel comprises a front substrate, a scan electrode and a sustain electrode positioned parallel to each other on the front substrate, an upper dielectric layer positioned on the scan electrode and the sustain electrode, the upper dielectric layer including a glass-based material and a cobalt (Co)-based material as a pigment, a rear substrate positioned to be opposite to the front substrate, and a barrier rib that is positioned between the front substrate and the rear substrate and partitions a discharge cell, wherein a ratio of a thickness of the upper dielectric layer to a content of the Co-based material ranges from 40 to 420.

In still another aspect, a plasma display panel comprises a front substrate, a scan electrode and a sustain electrode positioned parallel to each other on the front substrate, an upper dielectric layer positioned on the scan electrode and the sustain electrode, the upper dielectric layer including a glass-based material and a cobalt (Co)-based material as a pigment, a rear substrate positioned to be opposite to the front substrate, and a barrier rib that is positioned between the front substrate and the rear substrate and partitions a discharge cell, wherein the discharge cell is filled with a discharge gas, and the discharge gas includes xenon (Xe) of 10% to 30% based on total weight of the discharge gas.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIGS. 1A to 1C illustrate a structure of a plasma display panel according to an exemplary embodiment;

FIG. 2 illustrates an operation of the plasma display panel according to the exemplary embodiment;

FIG. 3 illustrates a composition of an upper dielectric layer;

FIG. 4 is a graph showing color coordinates of the plasma display panel according to the exemplary embodiment;

FIG. 5 is a table showing a relationship between a Co content and a thickness of an upper dielectric layer;

FIGS. 6A and 6b are a table and a graph showing characteristics of the plasma display panel depending on a content of pigment;

FIGS. 7A and 7B are a table and a graph showing a reflectance and a luminance depending on a thickness of an upper dielectric layer;

FIGS. 8A and 8B are tables showing a luminance and an efficiency depending on a Pb content;

FIGS. 9A and 9B are graphs showing a luminance and a firing voltage depending on a content of xenon (Xe);

FIGS. 10A and 10B illustrate a scan electrode and a sustain electrode each having a single-layered structure;

FIG. 11 illustrates a structure of a scan electrode and a sustain electrode;

FIGS. 12A and 12B illustrate a configuration of a scan electrode and a sustain electrode;

FIG. 13 illustrates a reason why an upper dielectric layer includes a pigment in a single-layered structure;

FIG. 14 is a graph showing color coordinates of the plasma display panel according to the exemplary embodiment;

FIG. 15 illustrates another structure of an upper dielectric layer;

FIG. 16 is a table explaining a thickness in each of a convex portion and a concave portion of an upper dielectric layer;

FIG. 17 illustrates another structure of an upper dielectric layer; and

FIGS. 18A to 18C illustrate another structure of a plasma display panel according to the exemplary embodiment.

### DETAILED DESCRIPTION OF EMBODIMENTS

Reference will now be made in detail embodiments of the invention examples of which are illustrated in the accompanying drawings.

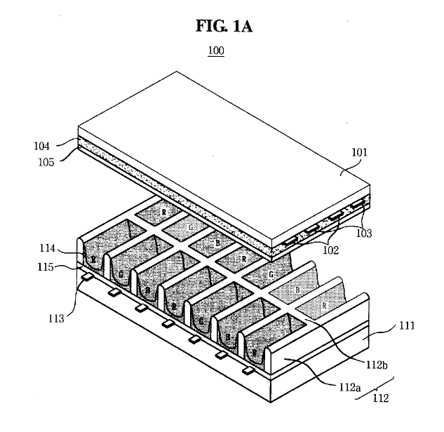

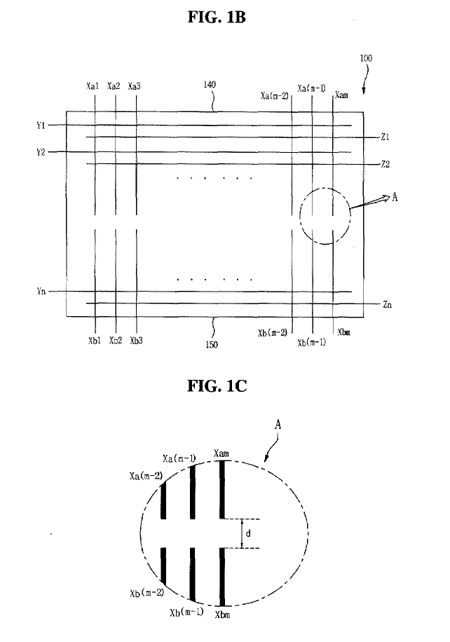

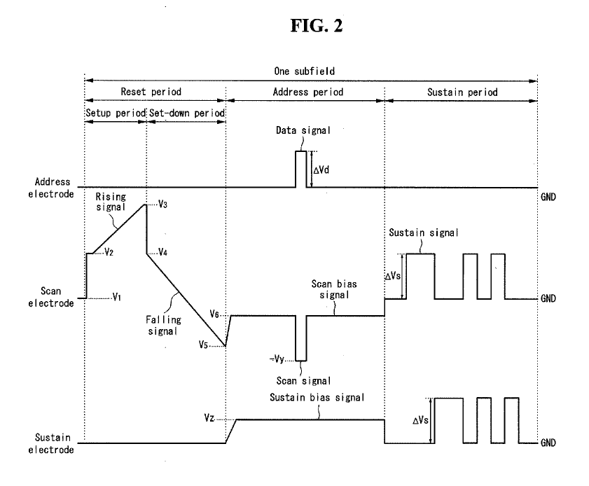

FIGS. 1A to 1C illustrate a structure of a plasma display panel according to an exemplary embodiment.

As illustrated in FIG. 1A, a plasma display panel 100 according to an exemplary embodiment includes a front substrate 101 and a rear substrate 111 which coalesce with each other using a seal layer (not shown) to be opposite to each other. On the front substrate 101, a scan electrode 102 and a sustain electrode 103 are positioned parallel to each other. On the rear substrate 111, an address electrode 113 is positioned to intersect the scan electrode 102 and the sustain electrode 103.

An upper dielectric layer 104 for covering the scan electrode 102 and the sustain electrode 103 is positioned on the front substrate 101 on which the scan electrode 102 and the sustain electrode 103 are positioned.

The upper dielectric layer 104 limits discharge currents of the scan electrode 102 and the sustain electrode 103, and provides electrical insulation between the scan electrode 102 and the sustain electrode 103.

A protective layer 105 is positioned on the upper dielectric layer 104 to facilitate discharge conditions. The protective layer 105 may include a material having a high secondary electron emission coefficient, for example, magnesium oxide (MgO).

A lower dielectric layer 115 for covering the address electrode 113 is positioned on the rear substrate 111 on which the address electrode 113 is positioned. The lower dielectric layer 115 provides electrical insulation of the address electrodes 113.

Barrier ribs 112 of a stripe type, a well type, a delta type, a honeycomb type, and the like, are positioned on the lower dielectric layer 115 to partition discharge spaces (i.e., discharge cells). A red (R) discharge cell, a green (G) discharge cell, and a blue (B) discharge cell, and the like, may be positioned between the front substrate 101 and the rear substrate 111. In addition to the red (R), green (G), and blue (B) discharge cells, a white (W) discharge cell or a yellow (Y) discharge cell may be positioned.

Each discharge cell partitioned by the barrier ribs 112 is filled with a discharge gas including Xe, Ne, and so forth.

A phosphor layer 114 is positioned inside the discharge cells to emit visible light for an image display during the generation of an address discharge. For instance, first, second and third phosphor layers respectively emitting red (R), blue (B) and green (G) light may be positioned inside the discharge cells. In addition to the red (R), green (G) and blue (B) light, a phosphor layer emitting white or yellow light may be positioned.

A thickness of at least one of the phosphor layers 114 formed inside the red (R), green (G) and blue (B) discharge cells may be different from thicknesses of the other phosphor layers. For instance, thicknesses of the second and third phosphor layers inside the blue (B) and green (G) discharge cells may be larger than a thickness of the first phosphor layer inside the red (R) discharge cell. The thickness of the second phosphor layer may be substantially equal or different from the thickness of the third phosphor layer.

Widths of the red (R), green (G), and blue (B) discharge cells may be substantially equal to one another. Further, a width of at least one of the red (R), green (G), or blue (B) discharge cells may be different from widths of the other discharge cells. For instance, a width of the red (R) discharge cell may be the smallest, and widths of the green (G) and blue (B) discharge cells may be larger than the width of the red (R) discharge cell. The width of the green (G) discharge cell may be substantially equal or different from the width of the blue (B) discharge cell.

A width of the phosphor layer 114 positioned inside the discharge cell changes depending on the width of the discharge cell. For instance, a width of the second phosphor layer may be larger than the width of the first phosphor layer, and also a width of the third phosphor layer may be larger than a width of the first phosphor layer. Hence, a color temperature of an image displayed on the plasma display panel can be improved.

The plasma display panel 100 according the exemplary embodiment may have various forms of barrier rib structures as well as a structure of the barrier rib 112 illustrated in FIG. 1A. For instance, the barrier rib 112 includes a first barrier rib 112b and a second barrier rib 112a.The barrier rib 112 may have a differential type barrier rib structure in which heights of the first and second barrier ribs 112b and 112a are different from each other.

In the differential type barrier rib structure, the height of the first barrier rib 112b may be smaller than the height of the second barrier rib 112a.

While FIG. 1A has been illustrated and described the case where the red (R), green (G) and blue (B) discharge cells are arranged on the same line, the red (R), green (G) and blue (B) discharge cells may be arranged in a different pattern. For instance, a delta type arrangement in which the red (R), green (G), and blue (B) discharge cells are arranged in a triangle shape may be applicable. Further, the discharge cells may have a variety of polygonal shapes such as pentagonal and hexagonal shapes as well as a rectangular shape.

While FIG. 1A has illustrated and described the case where the barrier rib 112 is formed on the rear substrate 111, the barrier rib 112 may be formed on at least one of the front substrate 101 or the rear substrate 111.

It should be noted that only one example of the plasma display panel according to the exemplary embodiment has been illustrated and described above, and the exemplary embodiment is not limited to the plasma display panel with the above-described structure. For instance, while the above description illustrates a case where the upper dielectric layer 104 and the lower dielectric layer 115 each have a sing-layered structure, at least one of the upper dielectric layer 104 or the lower dielectric layer 115 may have a multi-layered structure.

While the address electrode 113 positioned on the rear substrate 111 may have a substantially constant width or thickness, a width or thickness of the address electrode 113 inside the discharge cell may be different from a width or thickness of the address electrode 113 outside the discharge cell. For instance, a width or thickness of the address electrode 113 inside the discharge cell may be larger than a width or thickness of the address electrode 113 outside the discharge cell.

Referring to FIG. 1B, the plasma display panel 100 may be divided into a first area 140 and a second area 150.

In the first area 140, a plurality of first address electrodes Xa1, Xa1, . . . , Xam are positioned parallel to one another. In the second area 150, a plurality of second address electrodes Xb1, Xb1, . . . , Xbm are positioned parallel to one another to be opposite to the plurality of first address electrodes Xa1, Xa1, . . . , Xam.

FIG. 1C illustrates in detail an area A where the first address electrodes and the second address electrodes are opposite to each other.

As illustrated in FIG. 1C, the first address electrodes Xa(m-2), Xa(m-1) and Xam are opposite to the second address electrodes Xb(m-2), Xb(m-1) and Xbm with a distance d therebetween, respectively.

When the distance d between the first address electrode and the second address electrode is excessively small, it is likely that a current flows due to a coupling effect between the first address electrode and the second address electrode. On the other hand, when the distance d is excessively large, a user may watch a striped noise in an image displayed on the plasma display panel.

Considering this, the distance d may range from about 50 μm to 300 μm. Further, the distance d may range from about 70 μm to 220 μm.

FIG. 2 illustrates an operation of the plasma display panel according to the exemplary embodiment. The exemplary embodiment is not limited to FIG. 2, and an operation method of the plasma display can be variously changed.

As illustrated in FIG. 2, during a reset period for initialization of wall charges, a reset signal is supplied to the scan electrode. The reset signal includes a rising signal and a falling signal. The reset period is further divided into a setup period and a set-down period.

During the setup period, the rising signal is supplied to the scan electrode. The rising signal sharply rises from a first voltage V1 to a second voltage V2, and then gradually rises from the second voltage V2 to a third voltage V3. The first voltage V1 may be a ground level voltage GND.

The rising signal generates a weak dark discharge (i.e., a setup discharge) inside the discharge cell during the setup period, thereby accumulating a proper amount of wall charges inside the discharge cell.

During the set-down period, a falling signal of a polarity direction opposite a polarity direction of the rising signal is supplied to the scan electrode. The falling signal gradually falls from a fourth voltage V4 lower than a peak voltage (i.e., the third voltage V3) of the rising signal to a fifth voltage V5.

The falling signal generates a weak erase discharge (i.e., a set-down discharge) inside the discharge cell. Furthermore, the remaining wall charges are uniform inside the discharge cells to the extent that an address discharge can be stably performed.

During an address period following the reset period, a scan bias signal, which is maintained at a sixth voltage V6 higher than a lowest voltage (i.e., the fifth voltage V5) of the falling signal, is supplied to the scan electrode. A scan signal, which falls from the scan bias signal by a scan voltage magnitude ΔVy, is supplied to the scan electrode.

A width of a scan signal supplied during an address period of at least one subfield may be different from a width of a scan signal supplied during address periods of the other subfields. For instance, a width of a scan signal in a subfield may be larger than a width of a scan signal in the next subfield in time order. Further, a width of the scan signal may be gradually reduced in the order of 2.6 μs, 2.3 μs, 2.1 μs, 1.9 μs, etc., or in the order of 2.6 μs, 2.3 μs, 2.3 μs, 2.1 μs, 1.9 μs, 1.9 μs, etc.

As above, when the scan signal is supplied to the scan electrode, a data signal corresponding to the scan signal is supplied to the address electrode. The data signal rises from a ground level voltage GND by a data voltage magnitude ΔVd.

As the voltage difference between the scan signal and the data signal is added to the wall voltage generated during the reset period, the address discharge occurs within the discharge cell to which the data signal is supplied.

A sustain bias signal is supplied to the sustain electrode during the address period to prevent the generation of the unstable address discharge by interference of the sustain electrode.

The sustain bias signal is substantially maintained at a sustain bias voltage Vz. The sustain bias voltage Vz is lower than a voltage Vs of a sustain signal and is higher than the ground level voltage GND.

During a sustain period following the address period, a sustain signal is alternately supplied to the scan electrode and the sustain electrode. The sustain signal has a voltage magnitude corresponding to the sustain voltage Vs.

As the wall voltage within the discharge cell selected by performing the address discharge is added to the sustain voltage Vs, every time the sustain signal is supplied, the sustain discharge, i.e., a display discharge occurs between the scan electrode and the sustain electrode.

A plurality of sustain signals are supplied during a sustain period of at least one subfield, and a width of at least one of the plurality of sustain signals may be different from widths of the other sustain signals. For instance, a width of a first supplied sustain signal among the plurality of sustain signals may be larger than widths of the other sustain signals. Hence, a sustain discharge can be more stable.

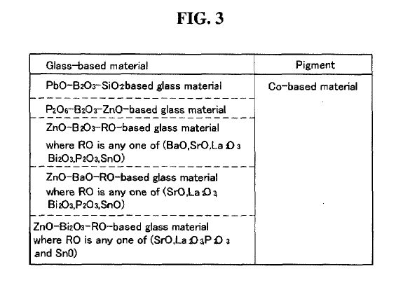

FIG. 3 illustrates a composition of an upper dielectric layer.

As illustrated in FIG. 3, an upper dielectric layer includes a glass-based material and a pigment, and has a blue-based color due to the pigment.

The glass-based material is not particularly limited. The glass-based material may be any one of P₂O₆—B₂O₃—ZnO-based glass material, ZnO—B₂O₃—RO-based glass material (where RO is any one of BaO, SrO, La₂O₃, Bi₂O₃, P₂O₃ and SnO), ZnO—BaO—RO-based glass material (where RO is any one of SrO, La₂O₃, Bi₂O₃, P₂O₃ and SnO), and ZnO—Bi₂O₃—RO-based glass mate (where RO is any one of SrO, La₂O₃, P₂O₃ and SnO), or a mixture of at least two of the above glass-based materials.

The pigment included in the upper dielectric layer is not particularly limited except that the upper dielectric layer has a blue-based color. The pigment may include cobalt (Co)-based material in consideration of the facility of powder manufacture, the color, and the manufacturing cost.

An example of a method of manufacturing the upper dielectric layer is as follows.

First, a glass-based material and a pigment are mixed. For instance, P₂O₆—B₂O₃—ZnO-based glass material and Co-based material are mixed.

A glass is manufactured using the glass-based material mixed with the pigment. In this case, a blue glass having a blue-based color due to cobalt is manufactured.

The manufactured blue glass is grinded to manufacture a blue glass powder. The particle size of the blue glass powder may range from about 0.1 μm to 10 μm.

The blue glass powder is mixed with a binder, a solvent, and the like to manufacture a dielectric paste. An additive such as a dispersion stabilizer may be added to the dielectric paste.

The dielectric paste is coated on the front substrate on which the scan electrode and the sustain electrode are formed. Then, the coated dielectric paste is dried and fired to form the upper dielectric layer.

Accordingly, the upper dielectric layer manufactured using the above manufacturing method can have a blue-based color.

Since the above description is only one example of the manufacturing method of the upper dielectric layer, the exemplary embodiment is not limited thereto. For instance, the upper dielectric layer may be manufactured using a laminating method.

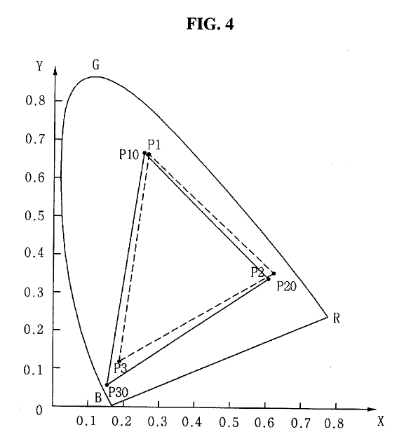

FIG. 4 is a graph showing color coordinates of a 1-typed panel and a 2-typed panel.

A 1-typed panel in which an upper dielectric layer includes Co-based material of 0.2 part by weight as a pigment and a 2-typed panel in which an upper dielectric layer does not include a pigment are manufactured. Then, color coordinates are measured using a photodetector (MCPD-1000) in a state where the same driving signal is supplied to the 1-typed and 2-typed panels.

As illustrated in FIG. 4, in the 2-typed panel, a green coordinate P1 has X-axis coordinate of about 0.272 and Y-axis coordinate of about 0.672; a red coordinate P2 has X-axis coordinate of about 0.630 and Y-axis coordinate of about 0.357; and a blue coordinate P3 has X-axis coordinate of about 0.190 and Y-axis coordinate of about 0.115.

In the 1-typed panel, a green coordinate P10 has X-axis coordinate of about 0.270 and Y-axis coordinate of about 0.670; a red coordinate P20 has X-axis coordinate of about 0.600 and Y-axis coordinate of about 0.340; and a blue coordinate P30 has X-axis coordinate of about 0.155 and Y-axis coordinate of about 0.060.

It can be seen from FIG. 4 that a triangle formed by connecting the coordinates P10, P20 and P30 of the 1-typed panel leans toward a blue direction as compared with a triangle formed by connecting the coordinates P1, P2 and P3 of the 2-typed panel. This means that a color temperature of the 1-typed panel is higher than a color temperature of the 2-typed panel. Hence, a viewer may think that an image displayed on the 1-typed panel is clearer than an image displayed on the 2-typed panel.

When an excessively large amount of pigment is added, a transmittance of the upper dielectric layer is reduced. Hence, a luminance of a displayed image may be excessively reduced. On the contrary, when an excessively small amount of pigment is added, an improvement effect of the color temperature may be small.

A content of pigment may be adjusted in consideration of a transmittance of the upper dielectric layer and a characteristic of the color coordinate.

When the upper dielectric layer has a blue-based color due to cobalt, the upper dielectric layer can absorb light coming from the outside of the panel. Hence, a contrast characteristic can be improved.

When a thickness of the upper dielectric layer increases in a state where a content of Co-based material is constant, a reflectance of the panel is reduced and a contrast characteristic is improved. However, because a transmittance of the panel is reduced, a luminance of a displayed image is reduced. When a content of Co-based material increases in a state where a thickness of the upper dielectric layer is constant, a reflectance of the panel is reduced and a contrast characteristic is improved. However, because a transmittance of the panel is reduced, a luminance of a displayed image is reduced.

Accordingly, a thickness of the upper dielectric layer may be determined depending on a content of Co-based material used as the pigment so as to raise a panel transmittance at a low panel reflectance.

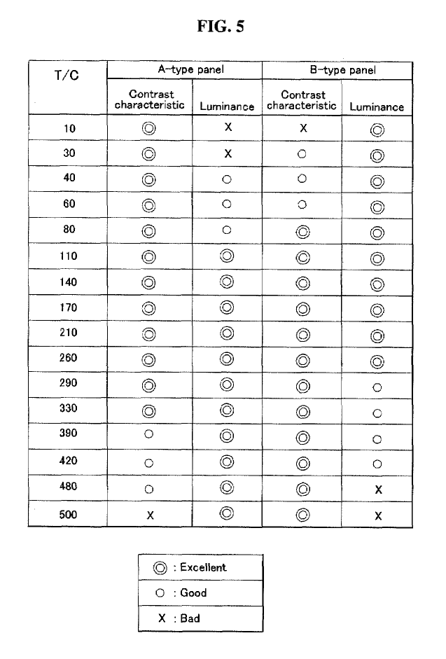

FIG. 5 is a table showing a contrast characteristic and a luminance of a displayed image depending on changes in a ratio of a thickness of an upper dielectric layer to a content of Co-based material.

In FIG. 5, T indicates a thickness of the upper dielectric layer in micrometer (μm), and C indicates a content of Co-based material in part by weight.

In an A-type panel, when a ratio T/C has a value of 10 to 500 by changing the content (C) of Co-based material in a state where the thickness T of the upper dielectric layer ranges from 33 μm to 39 μm, a contrast characteristic and a luminance of a displayed image are measured.

In a B-type panel, when a ratio T/C has a value of 10 to 500 by changing the thickness T of the upper dielectric layer in a state where the content (C) of Co-based material ranges from 0.1 to 0.6 part by weight, a contrast characteristic and a luminance of a displayed image are measured.

In FIG. 5, ⊚ indicates that a contrast characteristic and a luminance are excellent, ◯ indicates that a contrast characteristic and a luminance are good, and X indicates that a contrast characteristic and a luminance are bad.

In the A-type panel, when the ratio T/C ranges from 10 to 330, the contrast characteristic is excellent (⊚) because a reflectance of the upper dielectric layer is sufficiently high due to the addition of a sufficient amount of Co-based material with respect to the thickness T of the upper dielectric layer.

When the thickness T of the upper dielectric layer is 33 μm and the content (C) of Co-based material is a sufficient amount of 0.1 to 3.3 parts by weight, the ratio T/C has a value of 10 to 330. In this case, the contrast characteristic can be improved due to a sufficiently high reflectance of the upper dielectric layer.

When the ratio T/C ranges from 390 to 480, the contrast characteristic is good (◯). In this case, the contrast characteristic may be slightly reduced due to a low reflectance.

When the ratio T/C is equal to or more than 500, the contrast characteristic is bad (X) because a reflectance is excessively low due to the addition of an insufficient amount of Co-based material with respect to the thickness T of the upper dielectric layer.

When the thickness T of the upper dielectric layer is 39 μm and the content (C) of Co-based material is an insufficient amount of about 0.078 part by weight, the ratio T/C has a value equal to or more than 500. In this case, the contrast characteristic may worsen due to an excessively low reflectance of the upper dielectric layer.

In the A-type panel, when the ratio T/C ranges from 10 to 30, the luminance is bad (X) because a transmittance is excessively low due to the addition of an excessively large amount of Co-based material with respect to the thickness T of the upper dielectric layer.

When the ratio T/C ranges from 40 to 80, the luminance is good (◯). In this case, the luminance may be slightly reduced due to a low transmittance.

When the ratio T/C is equal to or more than 110, the luminance is excellent (⊚) because the transmittance is sufficiently high due to the addition of sufficiently small amount of Co-based material with respect to the thickness T of the upper dielectric layer.

In the B-type panel, when the ratio T/C is 10, the contrast characteristic is bad (X) because a reflectance of the upper dielectric layer is excessively low due to the excessively thin upper dielectric layer with respect to the content of Co-based material.

When the content of Co-based material is 0.1 part by weight and the thickness T of the upper dielectric layer is about 1 μm, the ratio T/C has a value of 10. In this case, the contrast characteristic may worsen due to an excessively low reflectance of the upper dielectric layer.

When the ratio T/C ranges from 30 to 60, the contrast characteristic is good (◯). In this case, the contrast characteristic may be slightly reduced due to a low reflectance.

When the ratio T/C is equal to or more than 80, the contrast characteristic is excellent (⊚) because the reflectance of the upper dielectric layer is sufficiently high due to the sufficiently thick thickness T of the upper dielectric layer with respect to the content of Co-based material.

When the content of Co-based material is 0.6 part by weight and the thickness T of the upper dielectric layer ranges from 48 μm to 300 μm, the ratio T/C has a value equal to or more than 80. In this case, the contrast characteristic can be improved due to a sufficiently high reflectance of the upper dielectric layer.

In the B-type panel, when the ratio T/C ranges from 10 to 260, the luminance is excellent (⊚) because a transmittance of the upper dielectric layer is sufficiently high due to the sufficiently thin thickness T of the upper dielectric layer with respect to the content of Co-based material.

When the ratio T/C ranges from 290 to 420, the luminance is good (◯). In this case, the luminance may be slightly reduced due to a low transmittance.

When the ratio T/C is equal to or more than 480, the luminance is bad (X) because the transmittance is excessively low due to the excessively thick upper dielectric layer with respect to the content of Co-based material.

Considering the description of FIG. 5, the ratio T/C of the thickness T of the upper dielectric layer to the content (C) of the Co-based material may range from 40 to 420. Further, the ratio T/C may range from 110 to 260.

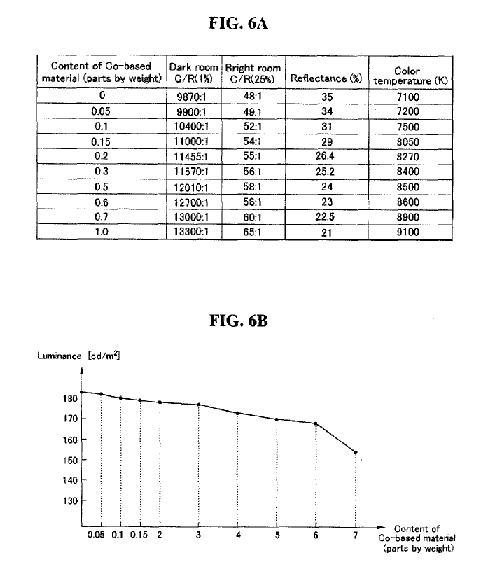

FIG. 6A is a table measuring a dark room contrast ratio, a bright room contrast ratio, a reflectance and a color temperature of the panel when a content of Co-based material is 0, 0.05, 0.1, 0.15, 0.2, 0.3, 0.5, 0.6, 0.7, and 1.0 part by weight, respectively. FIG. 6B is a graph showing a luminance of the panel under the same conditions as FIG. 6A. A thickness of the upper dielectric layer is fixed to 38 μm

The dark room contrast ratio measures a contrast ratio in a state where an image with a window pattern corresponding to 1% of the screen size is displayed in a dark room.

The bright room contrast ratio measures a contrast ratio in a state where an image with a window pattern corresponding to 25% of the screen size is displayed in a bright room.

As illustrated in FIG. 6A, when the upper dielectric layer does not include Co-based material, a dark room contrast ratio is 9870:1, a bright room contrast ratio is 48:1, a reflectance is 35%, and a color temperature is 7100K.

When the content of Co-based material is 0.05 part by weight, the dark room contrast ratio is 9900:1, the bright room contrast ratio is 49:1, the reflectance is 34%, and the color temperature is 7200K.

As above, when the upper dielectric layer includes a small amount of Co-based material equal to or less than 0.05 part by weight, the contrast ratio is reduced, the reflectance is high, and the color temperature is low.

When the content of Co-based material is 0.1 part by weight, the dark room contrast ratio is 10400:1, the bright room contrast ratio is 52:1, the reflectance is 31%, and the color temperature is 7500K. In other words, as the content of Co-based material increases, the contrast ratio increases, the reflectance is reduced, and the color temperature is increases.

The upper dielectric layer has a blue-based color due to the properties of the Co-based material, and thus can absorb light coming from the outside. Hence, the contrast characteristic is improved and the reflectance is reduced.

Further, when visible light coming from the inside of the panel is emitted to the outside of the panel through the upper dielectric layer having a blue-based color, blue visible light can be more clearly emitted due to the upper dielectric layer. Hence, the color temperature can be improved.

When the content of Co-based material ranges from 0.15 to 0.3 part by weight, the dark room contrast ratio ranges from 11000:1 to 11670:1, the bright room contrast ratio ranges from 54:1 to 56:1, the reflectance ranges from 25.2% to 29%, and the color temperature ranges from 8050K to 8400K. In other words, when the content of Co-based material ranges from 0.15 to 0.3 part by weight, the contrast ratio, the reflectance and the color temperature can be improved.

When the content of Co-based material is equal to or more than 0.5 part by weight, the dark room contrast ratio is equal to or more than 12010:1, the bright room contrast ratio is equal to or more than 58:1, the reflectance is equal to or less than 24%, and the color temperature is equal to or more than 8500K.

As illustrated in FIG. 6B, when the upper dielectric layer does not include the Co-based material, a luminance of a displayed image is about 183 cd/m².

When the content of Co-based material is 0.05 part by weight, the luminance is reduced to about 182 cd/m². Because the upper dielectric layer has a blue-based color due to the Co-based material, a transmittance of the upper dielectric layer is reduced and thus the luminance is reduced.

When the content of Co-based material is 0.1 part by weight, the luminance is about 180 cd/m². When the content of Co-based material ranges from 0.15 to 0.3 part by weight, the luminance ranges from about 177 to 179 cd/m².

When the content of Co-based material ranges from 0.4 to 0.6 part by weight, the luminance ranges from about 168 to 173 cd/m².

When the upper dielectric layer includes a large amount of Co-based material equal to or more than 0.7 part by weight, the transmittance of the upper dielectric layer is excessively reduced. Hence, the luminance is sharply reduced to a value equal to or less than about 154 cd/m².

Considering FIGS. 6A and 6B, the content of Co-based material as the pigment may range from 0.01 to 0.6 part by weight so as to prevent a reduction in the luminance caused by an excessive reduction in the transmittance of the upper dielectric layer while the reflectance is reduced and the contrast ratio and the color temperature increase. Further, the content of Co-based material may range from 0.15 to 0.3 part by weight.

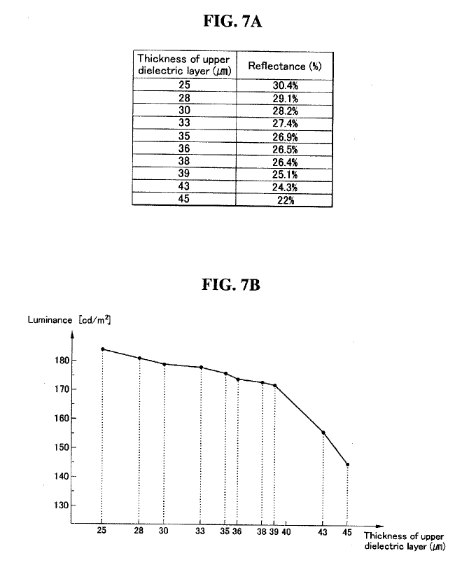

FIGS. 7A and 7B is a table and a graph showing a reflectance and a luminance measured when a thickness of the upper dielectric layer is 25 μm, 28 μm, 30 μm, 33 μm, 35 μm, 36 μm, 38 μm, 39 μm, 43 μm and 45 μm, respectively. In FIGS. 7A and 7B, the upper dielectric layer includes Co-based material of 0.2 part by weight.

As illustrated in FIG. 7A, when a thickness of the upper dielectric layer is 25 μm, it is difficult that the upper dielectric layer sufficiently absorbs light coming from the outside because of the excessively thin upper dielectric layer. Hence, a panel reflectance has a relatively high value of 30.4%.

When the thickness of the upper dielectric layer ranges from 28 μm to 30 μm, the panel reflectance has a relatively high value of 28.2% to 29.1%.

When the thickness of the upper dielectric layer is 33 μm, the panel reflectance is reduced to 27.4%.

When the thickness of the upper dielectric layer is equal to or more than 35 μm, the panel reflectance is equal to or less than 26.9% because of the thick upper dielectric layer.

As illustrated in FIG. 7B, when the thickness of the upper dielectric layer is 25 μm, a luminance of a displayed image is about 184 cd/m².

When the thickness of the upper dielectric layer ranges from 28 μm to 30 μm, the luminance ranges from about 179 cd/m² to 181 cd/m².

When the thickness of the upper dielectric layer is 33 μm, the luminance is about 178 cd/m².

When the thickness of the upper dielectric layer ranges from 35 μm to 39 μm, the luminance ranges from about 172 cd/m² to 176 cd/m².

When the thickness of the upper dielectric layer is equal to or more than 43 μm, the luminance is sharply reduced to a value equal to or less than about 156 cd/m².

Considering FIGS. 7A and 7B, the thickness of the upper dielectric layer may range from 33 μm to 39 μm so as to prevent a reduction in the luminance caused by an excessive reduction in a transmittance of the upper dielectric layer while the reflectance is reduced. Further, the thickness of the upper dielectric layer may range from 35 μm to 38 μm.

The pigment may further include at least one of a nickel (Ni)-based material, a chrome (Cr)-based material, a copper (Cu)-based material, a cerium (Ce)-based material and a manganese (Mn)-based material in addition to the Co-based material.

In case that the Ni-based material is added, the upper dielectric layer may be dark blue. Therefore, an image of dark blue can be more clearly displayed on the screen. When an excessively large amount of Ni-based material is added, the transmittance of the upper dielectric layer can be excessively reduced. Therefore, a content of Ni-based material may range from 0.1 to 0.2 part by weight.

In case that the Cr-based material is added, the upper dielectric layer may have a mixed color of red and blue. Therefore, an image with the mixed color can be more clearly displayed on the screen. In other words, a color representable range of the image can increase. A content of Cr-based material may range from 0.1 to 0.3 part by weight.

In case that the Cu-based material is added, the upper dielectric layer may have a mixed color of green and blue. Therefore, an image with the mixed color can be more clearly displayed on the screen. In other words, a color representable range of the image can increase. A content of Cu-based material may range from 0.03 to 0.09 part by weight.

In case that the Ce-based material is added, the upper dielectric layer may have a mixed color of yellow and blue. Therefore, an image with the mixed color can be more clearly displayed on the screen. In other words, a color representable range of the image can increase. A content of Ce-based material may range from 0.1 to 0.3 part by weight.

In case that the Mn-based material is added, a blue color of the upper dielectric layer may be deep. Therefore, a color temperature of a displayed image can increase. A content of Mn-based material may range from 0.2 to 0.6 part by weight.

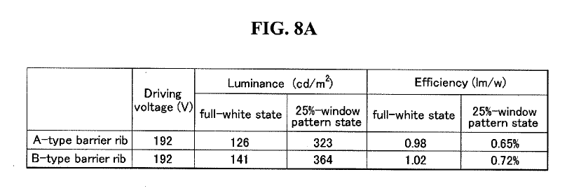

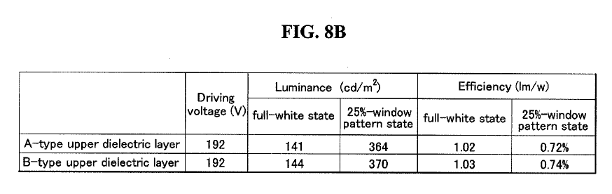

FIG. 8A is a table showing a luminance and an efficiency in each of an A-type barrier rib and a B-type barrier rib. In FIG. 8A, the upper dielectric layer is a complex-based dielectric layer including a Co-based material as a pigment.

Each of the luminance and the efficiency are measured in a full-white state, where all the discharge cells are turned on, and in a state an image with a window pattern corresponding to 25% of the screen size is displayed.

The A-type barrier rib is formed of PbO—B₂O₃—SiO₂ glass and includes lead (Pb) exceeding 1,000 ppm (parts per million). The B-type barrier rib includes Pb equal to or less than 1,000 ppm.

As illustrated in FIG. 8A, in the A-type barrier rib, when a driving voltage of 192V is applied between the scan electrode and the sustain electrode, the luminance of light is about 126 cd/m² and the efficiency is 0.98 lm/W in the full-white state, and the luminance of light is about 323 cd/M² and the efficiency is 0.65 lm/W in the state of 25%-window pattern.

In the B-type barrier rib, when a driving voltage of 192V is applied between the scan electrode and the sustain electrode, the luminance of light is about 141 cd/m² and the efficiency is 1.02 lm/W in the full-white state, and the luminance of light is about 364 cd/m² and the efficiency is 0.72 lm/W in the state of 25%-window pattern.

The luminance and the efficiency of the B-type barrier rib are larger than the luminance and the efficiency of the A-type barrier rib. The reason is that a capacitance of the B-type barrier rib including the Pb content less than the Pb content of the A-type barrier rib is lower than a capacitance of the A-type barrier rib, and thus a discharge current is reduced.

As above, when the Pb content of the upper dielectric layer is equal to or less than 1,000 ppm, a reduction in the luminance caused by a reduction in the transmittance of the upper dielectric layer can be prevented although the upper dielectric layer includes the Co-based material.

If Ph is accumulated inside the human body, Pb is a toxic material capable of adversely affecting the human body. Accordingly, when the barrier rib includes Pb equal to or less than 1,000 ppm in the plasma display panel according to the exemplary embodiment, an influence of Pb on the human body can be reduced.

FIG. 8B is a table showing a luminance and an efficiency in each of an A-type upper dielectric layer and a B-type upper dielectric layer. In FIG. 8B, the barrier rib includes Pb equal to or less than 1,000 ppm.

The A-type upper dielectric layer is formed of PbO—B₂0₃-SiO₂ glass and includes lead (Pb) exceeding 1,000 ppm. The B-type upper dielectric layer includes Pb equal to or less than 1,000 ppm.

As illustrated in FIG. 8B, in the A-type upper dielectric layer, when a driving voltage of 192V is applied between the scan electrode and the sustain electrode, the luminance of light is about 141 cd/M² and the efficiency is 1.02 lm/W in a full-white state, and the luminance of light is about 364 cd/m² and the efficiency is 0.72 lm/W in the state of 25%-window pattern.

In the B-type upper dielectric layer, when a driving voltage of 192V is applied between the scan electrode and the sustain electrode, the luminance of light is about 144 cd/M² and the efficiency is 1.03 lm/W in the full-white state, and the luminance of light is about 370 cd/m² and the efficiency is 0.74 lm/W in the state of 25%-window pattern.

The luminance and the efficiency of the B-type upper dielectric layer are larger than the luminance and the efficiency of the A-type upper dielectric layer. The reason is that a capacitance of the B-type upper dielectric layer including the Pb content less than the Pb content of the A-type upper dielectric layer is lower than a capacitance of the A-type upper dielectric layer, and thus a discharge current is reduced.

As above, when the Pb content of the upper dielectric layer is equal to or less than 1,000 ppm, a reduction in the luminance caused by a reduction in the transmittance of the upper dielectric layer can be prevented although the upper dielectric layer includes the Co-based material.

As described above, it is possible to prevent a reduction in the luminance caused by the addition of the pigment by setting the Pb content of the barrier rib or the upper dielectric layer to be equal to or less than 1,000 ppm. Further, it is possible to prevent a reduction in the luminance caused by the addition of the pigment by adjusting a content of xenon (Xe) included in the discharge gas

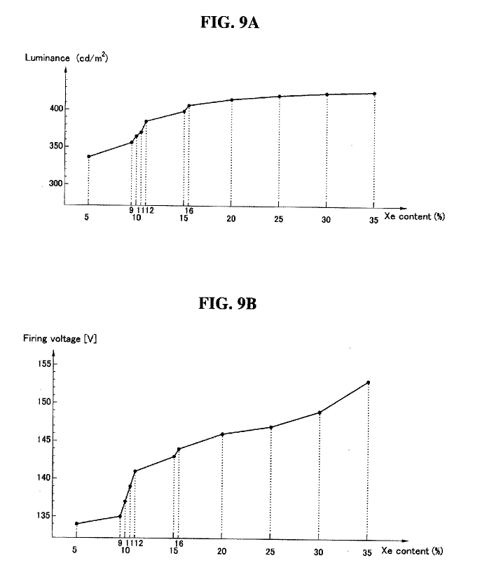

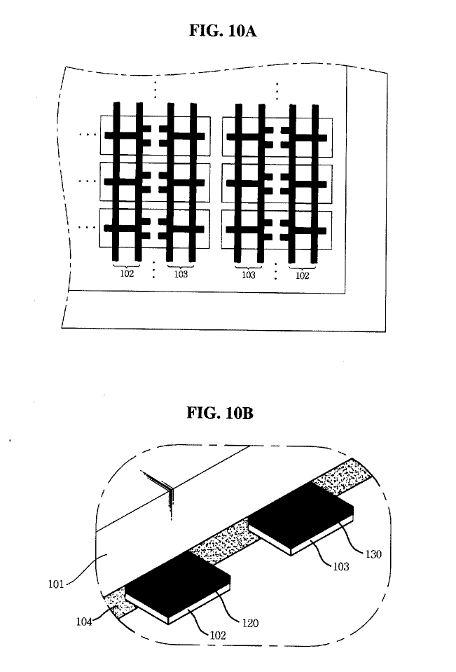

FIG. 9A is a graph showing a relationship between a luminance and a content of Xe included in the discharge gas when an image with a 25%-window pattern is displayed on the screen while the Xe content changes from 5% to 35% based on total weight of the discharge gas. FIG. 9B is a graph showing a relationship between a firing voltage between the scan and sustain electrodes and the Xe content under the same conditions as FIG. 9A.

As illustrated in FIG. 9A, when the Xe content is about 5%, a luminance of a displayed image is 338 cd/m². When the Xe content is about 9%, a luminance is 356 cd/m² and is relatively low.

When the Xe content is about 10%, a luminance increases to about 364 cd/m². Since Xe increases the generation amount of vacuum ultraviolet rays during the generation of a discharge, the quantity of light generated in the discharge cell increases due to an increase in the Xe content. Hence, the luminance increases.

When the Xe content is 11%, a luminance is about 370 cd/m². When the Xe content ranges from 12% to 15%, a luminance has a high value ranging from 384 cd/m² to 399 cd/m².

When the Xe content ranges from 16% to 30%, a luminance ranges from 406 cd/m² to 423 cd/M². When the Xe content is equal to or more than 35%, a luminance is about 425 cd/m².

As can be seen from FIG. 9A, as the Xe content increases, the luminance of the displayed image increases. On the other hand, when the Xe content is equal to or more than 35%, an increase width in the luminance is small.

As illustrated in FIG. 9B, when the Xe content is about 5%, a firing voltage between the scan and sustain electrodes is about 134V. When the Xe content is about 9%, the firing voltage is about 135V and relatively low. On the other hand, when the Xe content is about 10%, the firing voltage increases to about 137V.

Further, when the Xe content is about 11%, the firing voltage is about 139V. When the Xe content ranges from 12% to 15%, the firing voltage ranges from about 141V to 143V.

When the Xe content ranges from 16% to 30%, the firing voltage ranges from about 144V to 149V. When the Xe content is equal to or more than 35%, the firing voltage sharply increases to a value equal to or more about 153V.

As can be seen from FIG. 9B, as the Xe content increases, the firing voltage between the scan and sustain electrodes rises.

Accordingly, the discharge gas includes Xe of 10 to 30% so as to maintain the luminance at a sufficiently high level and to prevent an excessive rise in the firing voltage. The discharge gas may include Xe of 12 to 15%.

FIGS. 10A and 10B illustrate a scan electrode and a sustain electrode each having a single-layered structure.

As illustrated in FIGS. 10A and 10B, the scan electrode 102 and the sustain electrode 103 are positioned parallel to each other and have a single-layered structure,

Black layers 120 and 130 are positioned between the scan and sustain electrodes 102 and 103 and the front substrate 101.

The scan electrode 102 and the sustain electrode 103 may be formed of a metal material, which has excellent conductivity and is easy to mold, for instance, silver (Ag), gold (Au), copper (Cu) and aluminum (Al).

The scan and sustain electrodes 102 and 103 having the single-layered structure may be called an ITO-less electrode in which a transparent electrode is omitted.

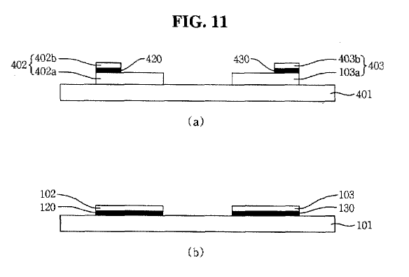

In FIG. 11, (a) illustrates a scan electrode 402 and a sustain electrode 403 each having a multi-layered structure, (b) illustrates a scan electrode 102 and a sustain electrode 103 each having a single-layered structure.

In (a) of FIG. 11, the scan electrode 402 and the sustain electrode 403 each include transparent electrodes 402a and 403a and bus electrodes 402b and 403b.

The bus electrodes 402b and 403b may include a substantially opaque material, for instance, at least one of Ag, Au, Cu or Al. The transparent electrodes 402a and 403a may include a substantially transparent material, for instance, indium-tin-oxide (ITO).

Black layers 402a and 403a are formed between the transparent electrodes 402a and 403a and the bus electrodes 402b and 403b to prevent the reflection of external light caused by the bus electrodes 402b and 403b.

A manufacturing method of the scan electrode 402 and the sustain electrode 403 in (a) of FIG. 11 is as follows. First, a transparent electrode layer is formed on a front substrate 401. Then, the transparent electrode layer is patterned to form the transparent electrodes 402a and 403a.

A bus electrode layer is formed on the transparent electrodes 402a and 403a. Then, the bus electrode layer is patterned to form the bus electrodes 402b and 403b.

On the other hand, the scan electrode 102 and the sustain electrode 103 in (b) of FIG. 11 is formed by forming an electrode layer on a front substrate 101 and patterning the electrode layer. In other words, since the manufacturing method in (b) of FIG. 11 is simpler than the manufacturing method in (a) of FIG. 11, manufacturing time and the manufacturing cost in (b) of FIG. 11 are reduced.

In (a) of FIG. 11, since the transparent electrodes 402a and 403a are formed of relatively expensive ITO, the transparent electrodes 402a and 403a provide a cause of a rise in the manufacturing cost.

In (b) of FIG. 11, since relatively expensive ITO is not used, the manufacturing cost is reduced.

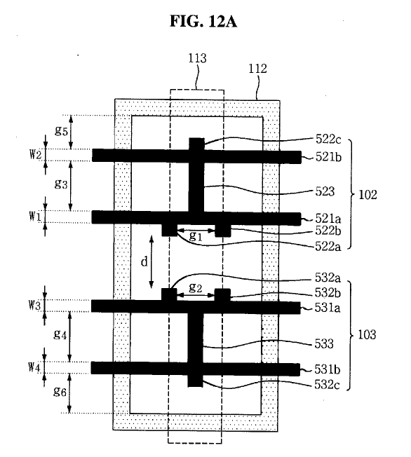

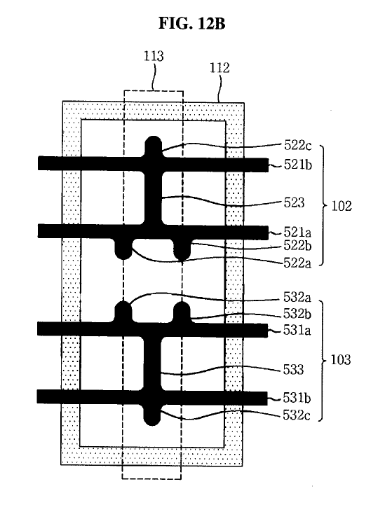

FIGS. 12A and 12B illustrate a configuration of a scan electrode and a sustain electrode.

As illustrated in FIG. 12A, the scan electrode 102 includes a plurality of line portions 521a and 521b intersecting the address electrode 113, and projecting portions 522a, 522b and 522c projecting from at least one of the line portions 521a and 521b. The sustain electrode 103 includes a plurality of line portions 531a and 531b intersecting the address electrode 113, and projecting portions 532a, 532b and 532c projecting from at the line portions 521a, 521b, 531a and 531b.

In FIG. 12A, the scan electrode 102 and the sustain electrode 103 each include three projecting portions. However, the number of projecting portions is not limited thereto. For instance, each of the scan electrode 102 and the sustain electrode 103 may include two projecting portions. The scan electrode 102 may include four projecting portions, and the sustain electrode 103 may include three projecting portions.

Further, the projecting portions 522c and 532c may be omitted from the scan electrode 102 and the sustain electrode 103, respectively.

The line portions 521a, 521b, 531a and 531b have a predetermined width, respectively. For instance, the first and second line portions 521a and 521b of the scan electrode 102 have widths of W1 and W2, respectively. The first and second line portions 531a and 531b of the sustain electrode 103 have widths of W3 and W4, respectively.

The widths W1, W2, W3 and W4 may have a substantially equal value. At least one of the widths W1, W2, W3 or W4 may have a different value. For instance, the widths W1 and W3 may be about 35 μm, and the widths W2 and W4 may be about 45 μm larger than the widths W1 and W3.

When an interval g3 between the first and second line portions 521a and 521b of the scan electrode 102 and an interval g4 between the first and second line portions 531a and 531b of the sustain electrode 103 are excessively large, it is difficult to diffuse a discharge generated between the scan electrode 102 and the sustain electrode 103 into the second line portion 521b of the scan electrode 102 and the second line portion 531b of the sustain electrode 103. On the other hand, the intervals g3 and g4 are excessively small, it is difficult to diffuse the discharge into the rear of the discharge cell. Accordingly, the intervals g3 and g4 may ranges from about 170 μm to 210 μm, respectively.

To sufficiently diffuse the discharge generated between the scan electrode 102 and the sustain electrode 103 into the rear of the discharge cell, a shortest interval g5 between the second line portion 521b of the scan electrode 102 and the barrier rib 112 in a direction parallel to the address electrode 113 and a shortest interval g6 between the second line portion 531b of the sustain electrode 103 and the barrier rib 112 in a direction parallel to the address electrode 113 may ranges from about 120 μm to 150 μm, respectively.

At least one of the projecting portions 522a, 522b, 522c, 532a, 532b and 532c projects from the line portions 521a, 521b, 531a and 531b toward the center of the discharge cell.

The projecting portions 522a, 522b, 522c, 532a, 532b and 532c are spaced apart from each other at a predetermined interval therebetween. For instance, the projecting portions 522a and 522b of the scan electrode 102 are spaced apart from each other at an interval of g1. The projecting portions 532a and 532b of the sustain electrode 103 are spaced apart from each other at an interval of g². The intervals g1 and g2 may ranges from about 75 μm to 110 μm, respectively, so as to secure the discharge efficiency.

A length of at least one of the projecting portions 522a, 522b, 522c, 532a, 532b and 532c may be different from a length of the other projecting portions. Lengths of the projecting portions each having a different projecting direction may be different from each other. For instance, lengths of the projecting portions 522a and 522b of the scan electrode 102 may be different from a length of the projecting portion 522c, and lengths of the projecting portions 532a and 532b of the sustain electrode 103 may be different from a length of the projecting portion 532c.

The scan electrode 102 and the sustain electrode 103 each include a connection portion for connecting at least two line portions. For instance, the scan electrode 102 includes a connection portion 523 for connecting the first and second line portions 521a and 521b, and the sustain electrode 103 includes a connection portion 533 for connecting the first and second line portions 531a and 531b.

A discharge may start to occur the between the projecting portions 522a and 522b projecting from the first line portion 521a of the scan electrode 102 and the projecting portions 532a and 532b projecting from the first line portion 531a of the sustain electrode 103.

The discharge is diffused into the first line portion 521a of the scan electrode 102 and the first line portion 531a of the sustain electrode 103, and then is diffused into the second line portion 521b of the scan electrode 102 and the second line portion 531b of the sustain electrode 103 through the connection portions 523 and 533.

The discharge diffused into the second line portions 521b and 531b is diffused into the rear of the discharge cell through the projecting portion 522c of the scan electrode 102 and the projecting portion 532c of the sustain electrode 103.

As illustrated in FIG. 12B, at least one of the projecting portions 521a, 521b, 521c, 531a, 531b and 531c may have a portion with the curvature. At least one of the projecting portions 521a, 521b, 521c, 531a, 531b and 531c may have an end portion with the curvature.

Further, a portion connecting the projecting portions 521a, 521b, 521c, 531a, 531b and 531c to the line portions 521a, 521b, 531a and 531b may have a curvature.

Further, a portion connecting the line portions 521a, 521b, 531a and 531b to the connection portions 523 and 533 may have a curvature.

As above, when the scan electrode 102 and the sustain electrode 103 each have the portion with the curvature, the scan electrode 102 and the sustain electrode 103 can be manufactured more easily. Further, the excessive accumulation of wall charges on a predetermined portion of the scan electrode 102 and the sustain electrode 103 can be prevented during a driving of the panel, and thus the panel can be stably driven.

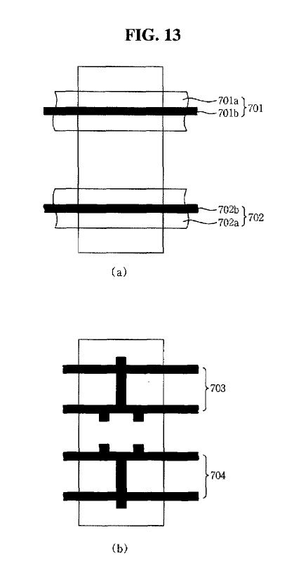

In FIG. 13, (a) illustrates a scan electrode 701 and a sustain electrode 702 each having a multi-layered structure in the same way as (a) of FIG. 11, and (b) illustrates a scan electrode 703 and a sustain electrode 704 each having a single-layered structure in the same way as (b) of FIG. 11.

In (a) of FIG. 13, the scan electrode 701 and the sustain electrode 702 each include transparent electrodes 701a and 702a and bus electrodes 701b and 702b.

As above, because the scan electrode 701 and the sustain electrode 702 each include the transparent electrodes 701a and 702a in (a) of FIG. 13, it does not matter that the entire area of the panel increases. On the other hand, because a transparent electrode is omitted in (b) of FIG. 13, an excessive increase in areas of the scan electrode 703 and the sustain electrode 704 excessively reduces an aperture ratio of the panel and thus a luminance of a displayed image may be excessively reduced.

In other words, because the scan electrode 701 and the sustain electrode 702 each include the transparent electrodes 701a and 702a in (a) of FIG. 13, areas of the scan electrode 701 and the sustain electrode 702 can increase by increasing areas of the transparent electrodes 701a and 702a. Hence, a driving voltage is reduced and thus the driving efficiency can be improved. Further, an aperture ratio of the panel is not reduced. On the other hand, when the areas of the scan electrode 703 and the sustain electrode 704 increase in (b) of FIG. 13, a driving voltage is reduced but an aperture ratio of the panel is excessively reduced. Hence, a luminance of a displayed image may be excessively reduced.

Accordingly, since the areas of the scan electrode 703 and the sustain electrode 704 having the single-layered structure may be relatively small, a diffusion level of a discharge in (b) of FIG. 13 may be smaller than a diffusion level of a discharge in (a) of FIG. 13. Accordingly, a generation area of visible light inside the discharge cell is not widely distributed and may be concentrated on a specific portion. As a result, a color sensitivity and a color temperature of a displayed image are reduced and the image quality worsens.

On the contrary, if an upper dielectric layer in (b) of FIG. 13 includes a Co-based material as a pigment, the upper dielectric layer has a blue-based color.

Accordingly, when visible light generated inside the discharge cell is emitted to the outside of the panel, blue visible light can be clearer by passing thorough the upper dielectric layer having the blue-based color. Hence, a color sensitivity and a color temperature of the displayed image can increase.

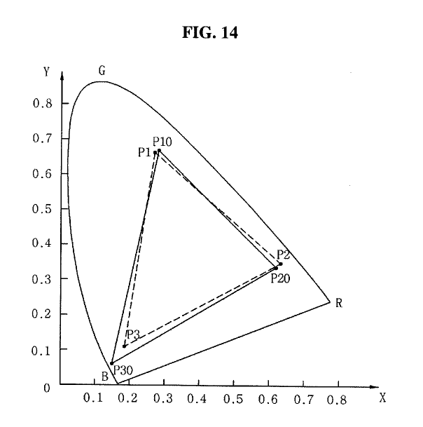

FIG. 14 is a graph showing color coordinates of a 1-typed panel and a 2-typed panel.

A 1-typed panel and a 2-typed panel are manufactured. In the 1-typed panel, an upper dielectric layer includes Co-based material of 0.2 part by weight as a pigment and a scan electrode and a sustain electrode each have a single-layered structure. In the 2-typed panel, an upper dielectric layer does not include a pigment and a scan electrode and a sustain electrode each have a single-layered structure. Then, color coordinates are measured using a photodetector (MCPD-1000) in a state where the same driving signal is supplied to the 1-typed and 2-typed panels.

As illustrated in FIG. 14, in the 2-typed panel, a green coordinate P1 has X-axis coordinate of about 0.270 and Y-axis coordinate of about 0.670; a red coordinate P2 has X-axis coordinate of about 0.628 and Y-axis coordinate of about 0.352; and a blue coordinate P3 has X-axis coordinate of about 0.195 and Y-axis coordinate of about 0.120.

In the 1-typed panel, a green coordinate P10 has X-axis coordinate of about 0.268 and Y-axis coordinate of about 0.673; a red coordinate P20 has X-axis coordinate of about 0.630 and Y-axis coordinate of about 0.359; and a blue coordinate P30 has X-axis coordinate of about 0.160 and Y-axis coordinate of about 0.070.

An area of a triangle formed by connecting the coordinates P10, P20 and P30 of the 1-typed panel is larger than an area of a triangle formed by connecting the coordinates P1, P2 and P3 of the 2-typed panel. This means that a color representable range of the 1-typed panel including the pigment is wider than a color representable range of the 2-typed panel not including the pigment. Hence, a color sensitivity of the 1-typed panel is more excellent than a color sensitivity of the 2-typed panel.

It can be seen from FIG. 14 that the triangle formed by connecting the coordinates P10, P20 and P30 of the 1-typed panel leans toward a blue direction as compared with the triangle formed by connecting the coordinates P1, P2 and P3 of the 2-typed panel. This means that a color temperature of the 1-typed panel is higher than a color temperature of the 2-typed panel. Hence, a viewer may think that an image displayed on the 1-typed panel is clearer than an image displayed on the 2-typed panel.

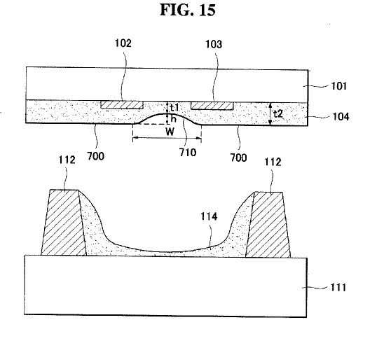

FIG. 15 illustrates another structure of an upper dielectric layer.

As illustrated in FIG. 15, the upper dielectric layer 104 includes a convex portion 700 and a concave portion 710 with a thickness smaller than a thickness of the convex portion 700.

The concave portion 710 may be positioned between the scan electrode 102 and the sustain electrode 103.

A largest thickness of the upper dielectric layer 104 (i.e., a thickness of the upper dielectric layer 104 in the convex portion 700) is t2, and a thickness of the upper dielectric layer 104 in the concave portion 710 is t1. A depth of the concave portion 710 is h, and a width of the concave portion 710 is W.

When a discharge occurs by applying a driving signal to the scan electrode 102 and the sustain electrode 103, most of wall charges may be accumulated on the concave portion 710. Therefore, a discharge path can shorten due to the structure of the upper dielectric layer 104 of FIG. 15. As a result, a firing voltage between the scan electrode 102 and the sustain electrode 103 is lowered and thus the driving efficiency can be improved.

A transmittance of the upper dielectric layer 104 with a blue-based color by including a Co-based material is smaller than a transmittance of the transparent upper dielectric layer 104 not including the Co-based material. Hence, a luminance of a displayed image may be reduced.

On the contrary, as illustrated in FIG. 15, when the upper dielectric layer 104 includes the convex portion 700 and the concave portion 710, a firing voltage between the scan electrode 102 and the sustain electrode 103 can be lowered and thus a reduction in the luminance caused by the Co-based material can be compensated.

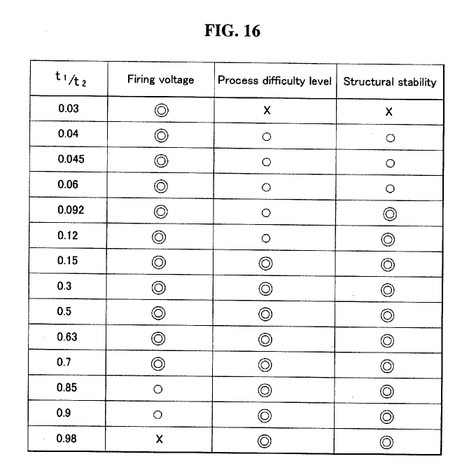

FIG. 16 is a graph showing a firing voltage between the scan electrode 102 and the sustain electrode 103 and a process difficulty level and a structural stability of the upper dielectric layer 104 when a ratio t1/t2 changes from 0.03 to 0.98 by changing the thickness t1 of the upper dielectric layer 104 in the concave portion 710 in a state where the thickness t2 of the upper dielectric layer 104 in the convex portion 700 is fixed to 38 μm.

FIG. 16, ⊚ indicates that the firing voltage is sufficiently low, the upper dielectric layer 104 is easy to manufacture, and the structural stability of the upper dielectric layer 104 is excellent; ◯ indicates a good state; and X indicates a bad state.

As illustrated in FIG. 16, when the ratio t1/t2 ranges from 0.03 to 0.7, the firing voltage is sufficiently low because wall charges are sufficiently accumulated on the concave portion 710.

When the ratio t1/t2 ranges from 0.85 to 0.9, the firing voltage is low.

When the ratio t1/t2 is equal to or more than 0.98, the firing voltage is high because wall charges cannot sufficiently accumulated on the concave portion 710.

When the ratio t1/t2 is 0.03, the front substrate may be exposed to the outside of the upper dielectric layer because it is difficult to accurately arrange manufacturing equipments due to the excessively thin concave portion 710. Further, manufacturing time required to manufacture the excessively thin concave portion 710 may increase. Hence, the process difficulty level is bad.

When the ratio t1/t2 ranges from 0.04 to 0.12, the process difficulty level of the upper dielectric layer is good because the thickness t1 of the concave portion 710 is proper.

When the ratio t1/t2 is equal to or more than 0.15, manufacturing time required to manufacture the concave portion 710 may be reduced. Further, although the manufacturing equipments are not accurately arranged, the concave portion 710 can be stably manufactured. Hence, the process difficulty level of the upper dielectric layer is excellent.

When the ratio t1/t2 is 0.03, a difference between the thickness t1 of the convex portion 700 and the thickness t1 of the concave portion 710 is large. Since it is likely that the convex portion 700 is broken, the structural stability of the upper dielectric layer is bad.

When the ratio t1/t2 ranges from 0.04 to 0.06, the structural stability of the upper dielectric layer is good because the thickness t1 of the concave portion 710 is proper.

When the ratio t1/t2 is equal to or more than 0.092, the structural stability of the upper dielectric layer is excellent because a difference between the thickness t1 of the convex portion 700 and the thickness t1 of the concave portion 710 is small.

The ratio t1/t2 of the thickness t1 of the convex portion 700 to the thickness t1 of the concave portion 710 may range from 0.04 to 0.9 so as to reduce the firing voltage between the scan electrode and the sustain electrode, reduce the process difficulty level of the upper dielectric layer and improve the structural stability of the upper dielectric layer. The ratio t1/t2 may range from 0.15 to 0.7.

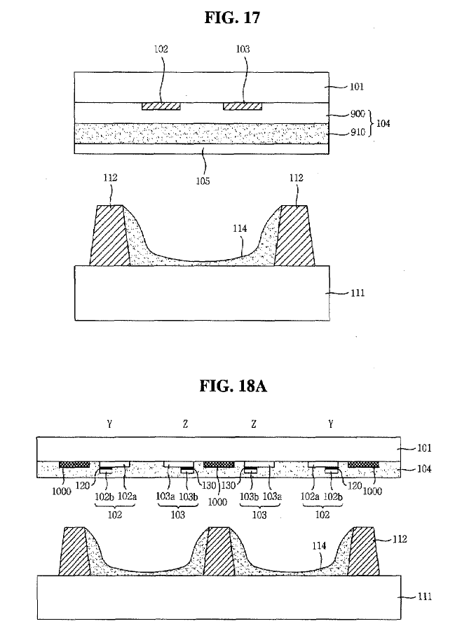

FIG. 17 illustrates another structure of an upper dielectric layer.

As illustrated in FIG. 17, the upper dielectric layer 104 has a two-layered structure. For instance, the upper dielectric layer 104 includes a first upper dielectric layer 900 and a second upper dielectric layer 910 which are stacked in turn.

At least one of the first upper dielectric layer 900 and the second upper dielectric layer 910 may include a pigment.

If the upper dielectric layer 104 includes a metal pigment, a permittivity of the upper dielectric layer 104 may be reduced.

A permittivity of the first upper dielectric layer 900 may be relatively high because the first upper dielectric layer 900 covers the scan electrode 102 and the sustain electrode 103 and provides insulation between the scan electrode 102 and the sustain electrode 103. Therefore, the first upper dielectric layer 900 may not include a pigment, and the second upper dielectric layer 910 positioned on the first upper dielectric layer 900 may include a pigment.

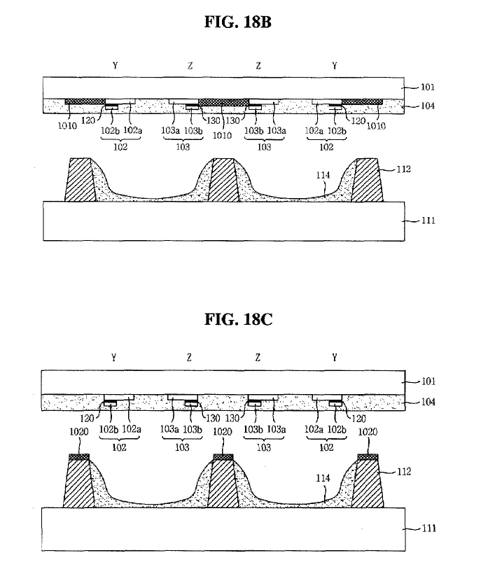

FIGS. 18A to 18C illustrate another structure of a plasma display panel according to the exemplary embodiment.

As illustrated in FIG. 18A, a black matrix 1000 overlapping the barrier rib 112 is positioned on the front substrate 101. The black matrix 1000 absorbs incident light and thus suppresses the reflection of light caused by the barrier rib 112. Hence, a panel reflectance is reduced and a contrast characteristic can be improved.

In FIG. 18A, the black matrix 1000 is positioned on the front substrate 101. However, the black matrix 1000 may be positioned on the upper dielectric layer (not shown).

Black layers 120 and 130 are positioned between the transparent electrodes 102a and 103a and the bus electrodes 102b and 103b. The black layers 120 and 130 prevent the reflection of light caused by the bus electrodes 102b and 103b, thereby reducing a panel reflectance.

As illustrated in FIG. 18B, a common black matrix 1010 contacting the two sustain electrodes 103 is positioned between the two sustain electrodes 103. The common black matrix 1010 may be formed of the substantially same materials as the black layers 120 and 130. In this case, since the common black matrix 1010 can be manufactured when the black layers 120 and 130 is manufactured, time required in a manufacturing process can be reduced.

As illustrated in FIG. 18C, a top black matrix 1020 is directly formed on the barrier rib 112. Since the top black matrix 1020 reduces a panel reflectance, a black matrix may not be formed on the front substrate 101.

As described above, when the upper dielectric layer includes a pigment, the panel reflectance can be further reduced.

The black layers 120 and 130, the black matrix 1000, the common black matrix 1010 and the top black matrix 1020 may be omitted from the plasma display panel. Because the pigment mixed with the upper dielectric layer 104 can sufficiently reduce the panel reflectance, a sharp increase in the panel reflectance can be prevented although the black layers 120 and 130, the black matrix 1000, the common black matrix 1010 and the top black matrix 1020 are omitted.

A removal of the black layers 120 and 130, the black matrix 1000, the common black matrix 1010 and the top black matrix 1020 can make a manufacturing process of the panel simpler, and reduce the manufacturing cost.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display panel comprising:
a front substrate;
a scan electrode and a sustain electrode positioned parallel to each other on the front substrate;
an upper dielectric layer positioned on the scan electrode and the sustain electrode, the upper dielectric layer including a glass-based material and a cobalt (Co)-based material as a pigment;
a rear substrate on which an address electrode is positioned to intersect the scan electrode and the sustain electrode; and
a barrier rib that is positioned between the front substrate and the rear substrate and partitions a discharge cell, the barrier rib including lead (Pb) equal to or less than 1,000 ppm (parts per million).

2. The plasma display panel of claim 1, wherein a content of the Co-based material ranges from 0.1 to 0.6 part by weight.

3. The plasma display panel of claim 1, wherein a content of the Co-based material ranges from 0.15 to 0.3 part by weight.

4. The plasma display panel of claim 1, wherein the pigment include at least one of a nickel (Ni)-based material, a chrome (Cr)-based material, a copper (Cu)-based material, a cerium (Ce)-based material and a manganese (Mn)-based material.

5. The plasma display panel of claim 4, wherein a content of the Ni-based material ranges from 0.1 to 0.2 part by weight, a content of the Cr-based material ranges from 0.1 to 0.3 part by weight, a content of the Cu-based material ranges from 0.03 to 0.09 part by weight, a content of the Ce-based material ranges from 0.1 to 0.3 part by weight, and a content of the Mn-based material ranges from 0.2 to 0.6 part by weight.

6. The plasma display panel of claim 1, wherein a thickness of the upper dielectric layer ranges from 33 μm to 39 μm.

7. The plasma display panel of claim 1, wherein the upper dielectric layer includes Pb equal to or less than 1,000 ppm.

8. The plasma display panel of claim 1, wherein the scan electrode and the sustain electrode each have a single-layered structure.

9. The plasma display panel of claim 8, wherein the scan electrode and the sustain electrode each include a plurality of line portions intersecting the address electrode, at least one connection portion connecting at least two line portions of the plurality of line portions, and at least one projecting portion projecting from the plurality of line portions.

10. A plasma display panel comprising:
a front substrate;
a scan electrode and a sustain electrode positioned parallel to each other on the front substrate;
an upper dielectric layer positioned on the scan electrode and the sustain electrode, the upper dielectric layer including a glass-based material and a cobalt (Co)-based material as a pigment;
a rear substrate positioned to be opposite to the front substrate; and
a barrier rib that is positioned between the front substrate and the rear substrate and partitions a discharge cell,
wherein a ratio of a thickness of the upper dielectric layer to a content of the Co-based material ranges from 40 to 420.

11. The plasma display panel of claim 10, wherein the ratio of the thickness of the upper dielectric layer to the content of the Co-based material ranges from 110 to 260.

12. The plasma display panel of claim 10, wherein a content of the Co-based material ranges from 0.1 to 0.6 part by weight.

13. The plasma display panel of claim 10, wherein a content of the Co-based material ranges from 0.15 to 0.3 part by weight.

14. The plasma display panel of claim 10, wherein the barrier rib includes Pb equal to or less than 1,000 ppm.

15. The plasma display panel of claim 10, wherein the upper dielectric layer includes Pb equal to or less than 1,000 ppm.

16. A plasma display panel comprising:
a front substrate;
a scan electrode and a sustain electrode positioned parallel to each other on the front substrate;
an upper dielectric layer positioned on the scan electrode and the sustain electrode, the upper dielectric layer including a glass-based material and a cobalt (Co)-based material as a pigment;
a rear substrate positioned to be opposite to the front substrate; and
a barrier rib that is positioned between the front substrate and the rear substrate and partitions a discharge cell,
wherein the discharge cell is filled with a discharge gas, and the discharge gas includes xenon (Xe) of 10% to 30% based on total weight of the discharge gas.

17. The plasma display panel of claim 16, wherein the discharge gas includes Xe of 12% to 15% based on total weight of the discharge gas.

18. The plasma display panel of claim 16, wherein a content of the Co-based material ranges from 0.1 to 0.6 part by weight.

19. The plasma display panel of claim 16, wherein a content of the Co-based material ranges from 0.15 to 0.3 part by weight.

20. The plasma display panel of claim 16, wherein the barrier rib includes lead (Pb) equal to or less than 1,000 ppm (parts per million).
